(19) United States
(12) Patent Application Publication
(10) Pub. No.: US 2026/0170862 A1
(43) Pub. Date: Jun. 18, 2026

(54) SYSTEM AND METHOD FOR ENTERPRISE DOCUMENT PROCESSING USING COGNITIVE INTELLIGENCE BASED FEATURE ENGINEERING

(71) Applicant: COGNIQUEST TECHNOLOGIES PRIVATE LIMITED, BANGALORE (IN)

(72) Inventors: HARSHA A C, BANGALORE (IN); THEJASWI SUBRAMANYA, BANGALORE (IN); NATHANIEL N, BANGALORE (IN); GIRISH KERODI NAGARAJ, BANGALORE (IN); SATISH GRAMPUROHIT, BANGALORE (IN)

(21) Appl. No.: 19/424,306

(22) Filed: Dec. 18, 2025

(30) Foreign Application Priority Data
Dec. 18, 2024 (IN) 202441100579

(51) Int. Cl. G06V 30/414; G06N 5/022; G06T 5/70

(52) U.S. Cl. CPC G06V 30/414; G06N 5/022; G06T 5/70

(57) ABSTRACT

A system and a method for enterprise document processing using cognitive intelligence is disclosed. The processing subsystem 105 includes a receiving module 120 to receive a document set. A multi-modal cognitive intelligence layer module 125 to analyze content in the document set. The multi-modal cognitive intelligence layer module 125 includes a data compositive intelligence module 130 to provide a hierarchy of a plurality of logical components. The multi-modal cognitive intelligence layer module 125 includes a linguistic intelligence module 140 to generate a knowledge graph for the document set. The multi-modal cognitive intelligence layer module 125 includes a mathematical intelligence module 150 configured to analyze numerical attributes from the document set to understand a plurality of corresponding numerical relationships between a plurality of data units. The multi-modal cognitive intelligence layer module 125 includes a domain intelligence module 160 that allows subject matter experts to configure domain knowledge into the document set.

### EARLIEST PRIORITY DATE

This Application claims priority from a complete patent application filed in India having Patent Application No. 202441100579, filed on 18th day of December 2024, and titled “SYSTEM AND METHOD FOR ENTERPRISE DOCUMENT PROCESSING USING COGNITIVE INTELLIGENCE BASED FEATURE ENGINEERING”.

### FIELD OF INVENTION

Embodiments of the present disclosure relate to the field of document text processing, and more particularly, a system and a method for enterprise document processing using cognitive intelligence based feature engineering.

### BACKGROUND

Every enterprise creates, collects, and stores business documents. The documents can vary from project documents, marketing material, business details, client information and the like. Keeping an overview of the documents and organizing the documents accordingly in one place remains a challenge.

Further, the documents may include several types of documents, for example structured data, unstructured data and semi-structured data. The ability to analyze and understand documents in data intensive enterprise and analyze the data is critical for intelligent decision-making in a successful organization. This is where document processing and automated data extraction classification and analytics adds value to the enterprise. It is relatively simple to extract information programmatically from a well-defined or organized data model. However, when electronic documents include large documents that may be structured documents, semi-structured documents, and unstructured documents, extracting information from these documents may become technically difficult. The information from these documents may frequently lack a well-defined data model, making it difficult to reliably parse and extract the required information from the document.

Currently, there are several techniques for document processing. However, these techniques are limited to template-based processing. In other words, document processing is performed only if the documents adhere to specific pre-defined templates. Another drawback of the existing techniques is the accuracy of extracting information from the documents, specifically in unstructured documents. Typically, the accuracy is presented as flags in percentage terms which leads to ambiguity. Further, the existing techniques are very limited with respect to delivering optimal results and falls short in case of complex documents.

Hence, there is a need for an improved system and method for enterprise document processing using cognitive intelligence which addresses the aforementioned issue(s).

### OBJECTIVE OF THE INVENTION

An objective of the invention is to analyze documents pertaining to various formats by utilizing multiple cognitive intelligence layers to understand the type of data in the context and its relationship with other data context.

Another objective of the invention is to apply multi-modal techniques to understand the documents that includes structured data, unstructured data, and semi-structured data through structural, numerical, linguistic, and domain perspectives.

### BRIEF DESCRIPTION

In accordance with an embodiment of the present disclosure, a system for enterprise document processing using multi-modal cognitive intelligence layers is provided. The system includes a processing subsystem hosted on a server. The processing subsystem is configured to execute on a network to control bidirectional communications among a plurality of modules. The processing subsystem includes a receiving module operatively coupled to the processing subsystem configured to receive a document set wherein the document set includes structured data, unstructured data, and semi-structured data. The processing subsystem further includes a layer module operatively coupled to the receiving module including a plurality of modules to analyze content in the document set upon receiving the document set, wherein the layer module includes a data compositive intelligence module configured to provide a hierarchy of one or more logical components upon understanding a structure of the content in the document set. The data compositive intelligence module is also configured to derive a plurality of clusters, wherein each cluster represents a semantic relationship between each of the plurality of logical components of the document set. The layer module also includes a linguistic intelligence module configured to analyze one or more textual components from the document set wherein the textual components include one or more paragraphs, sentences, and clause structures. The linguistic intelligence module is also configured to link each of the plurality of textual components to a corresponding plurality of attributes. The linguistic intelligence module is further configured to generate a knowledge graph for the document set upon understanding the relationship between the plurality of textual components. Further, the layer module includes a mathematical intelligence layer module configured to analyze a plurality of numerical attributes from the document set to understand a plurality of corresponding numerical relationships between one or more data units, wherein the data units pertains to the document set. Additionally, the layer module includes a domain intelligence layer module configured to allow subject matter experts to configure domain knowledge into the document set.

In accordance with another embodiment of the present disclosure, a method for enterprise document processing using cognitive intelligence is provided. The method includes receiving, by a receiving module of a processing subsystem, a document set wherein the document set includes structured data, unstructured data, and semi-structured data. The method also includes analyzing, by a layer module of the processing subsystem, content in the document set upon receiving the document set. Further, the method includes providing, by a data compositive intelligence of a layer module, a hierarchy of a plurality of logical components upon understanding a structure of the content in the document set. Further, the method also includes deriving, by a data compositive intelligence of the layer module, a plurality of clusters, wherein each cluster represents a semantic relationship between each of the plurality of logical components of the document set. The method includes analyzing, by a linguistic intelligence module of the layer module, a plurality of textual components from the document set wherein the textual components includes a plurality of paragraphs, sentences, and clause structures. The method also includes linking, by a linguistic intelligence module of the layer module, each of the plurality of textual components to a corresponding plurality of attributes. Furthermore, the method includes generating, by a linguistic intelligence module of the layer module, a knowledge graph for the document set upon understanding the relationship between the plurality of textual components. Furthermore, the method also includes analyzing, by a mathematical intelligence layer module of the layer module, a plurality of numerical attributes from the document set to understand a plurality of corresponding numerical relationships between a plurality of data units, wherein the plurality of data units pertains to at least one of the document set and across a set of the document set. Additionally, the method includes allowing, by a domain intelligence layer module of the layer module, subject matter experts to configure domain knowledge into the document set.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for enterprise document processing using multi-modal cognitive intelligence in accordance with an embodiment of the present disclosure;

FIG. 2 is a block diagram of a data compositive intelligence module of FIG. 1 in accordance with an embodiment of the present disclosure;

FIG. 3 is a block diagram of a linguistic intelligence module of FIG. 1 in accordance with an embodiment of the present disclosure;

FIG. 4 is a block diagram of a mathematical intelligence module of FIG. 1 in accordance with an embodiment of the present disclosure;

FIG. 5 is a block diagram of a domain intelligence module of FIG. 1 in accordance with an embodiment of the present disclosure;

FIG. 6 is a block diagram of a computer or a server in accordance with an embodiment of the present disclosure;

FIG. 7(a) illustrates a flow chart representing the steps involved in a method for enterprise document processing using cognitive intelligence in accordance with an embodiment of the present disclosure; and

FIG. 7(b) illustrates continued steps of the method of FIG. 7(a) in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relates to a system for enterprise document processing using multi-modal cognitive intelligence. The processing subsystem is configured to execute on a network to control bidirectional communications among a plurality of modules. The processing subsystem includes a receiving module operatively coupled to the processing subsystem configured to receive a document set wherein the document set includes structured data, unstructured data, and semi-structured data. The processing subsystem further includes a layer module operatively coupled to the receiving module including a plurality of modules to analyze content in the document set upon receiving the document set, wherein the layer module includes a data compositive intelligence module configured to provide a hierarchy of a plurality of logical components upon understanding a structure of the content in the document set. The data compositive intelligence module is also configured to derive a plurality of clusters, wherein each cluster represents a semantic relationship between each of the plurality of logical components of the document set. The layer module also includes a linguistic intelligence module configured to analyze one or more textual components from the document set wherein the textual components include paragraphs, sentences, and clause structures. The linguistic intelligence module is also configured to link each of the plurality of textual components to a corresponding plurality of attributes. The linguistic intelligence module is further configured to generate a knowledge graph for the document set upon understanding the relationship between the plurality of textual components. Further, the layer module includes a mathematical intelligence layer module configured to analyze one or more numerical attributes to understand corresponding numerical relationships between data units, wherein the data units pertains to the document set. Additionally, the layer module includes a domain intelligence layer module configured to allow subject matter experts to configure domain knowledge into the document set.

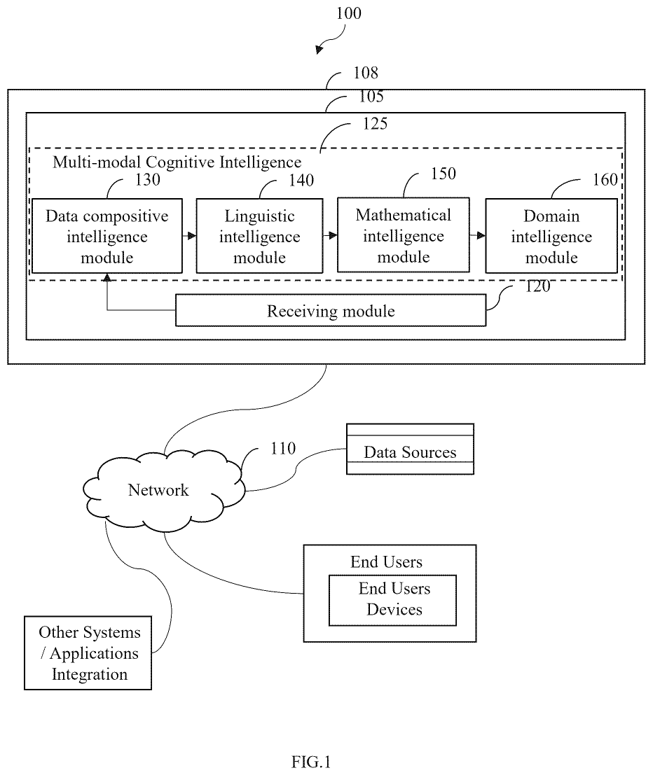

FIG. 1 is a block diagram of a system 100 for enterprise document processing using cognitive intelligence is provided in accordance with an embodiment of the present disclosure. The system 100 includes a processing subsystem 105 hosted on a server 108. In one embodiment, the server 108 may include a cloud-based server. In another embodiment, parts of the server 108 may be a local server coupled to a user device (not shown in FIG. 1). The user device includes, but is not limited to, a mobile phone, desktop computer, portable digital assistant (PDA), smart phone, tablet, ultra-book, netbook, laptop, multi-processor system, microprocessor-based or programmable consumer electronic system, or any other communication device that a user may use. In some embodiments, the system may comprise a display module (not shown) to display information (for example, in the form of user interfaces). In further embodiments, the system may comprise one or more touch screens, accelerometers, gyroscopes, cameras, microphones, global positioning system (GPS) devices, and so forth.

The processing subsystem 105 is configured to execute on a network 115 to control bidirectional communications among a plurality of modules. In one example, the network 115 may be a private or public local area network (LAN) or Wide Area Network (WAN), such as the Internet. In another embodiment, the network 115 may include both wired and wireless communications according to one or more standards and/or via one or more transport mediums. In one example, the network 115 may include wireless communications according to one of the 802.11 or Bluetooth specification sets, or another standard or proprietary wireless communication protocol. In yet another embodiment, the network 115 may also include communications over a terrestrial cellular network, including, a global system for mobile communications (GSM), code division multiple access (CDMA), and/or enhanced data for global evolution (EDGE) network.

The system 100 includes a receiving module 120 operatively coupled to the processing subsystem 105 configured to receive a document set or documents. As used herein, the document set may vary in format, for instance an image, portable document format (PDF), word document and the like. The document set includes structured data, unstructured data, and semi-structured data. Typically, the structured data is data that is in a standardized format, has a well-defined structure, and is easily accessed by users. For example, the structured data may include names, dates, and addresses. The unstructured data is qualitative data and may not be processed or analyzed using standard tools and methods. For example, the unstructured data may include text, email, press releases, video files, audio files, social media posts, news reports, and images. The semi-structured data is data that does not consist of structured data but has some structure. The semi-structured data may be invoices and bank statements. Each invoice may differ from one company to another company, but all companies carry the same information, such as vendor details, supplier details, and goods and service tax number (GSTN).

In one embodiment, the document set are pre-processed to reduce noise, correct skew, and convert the format.

The system 100 also includes a multi-modal cognitive intelligence layer module 125 operatively coupled to the receiving module 120 comprising a plurality of modules to analyze content in the document set upon receiving the document set. It must be noted that the analysis of the content is data centric. The multi-modal cognitive intelligence layer module 125 includes a data compositive intelligence module 130 configured to provide a hierarchy of a plurality of logical components upon understanding a structure of the content in the document set. Typically, the hierarchy is used to map the information in the document set. For example, the hierarchy of the book may be a title, chapter headers, sub-headers, paragraphs, sub-paragraphs, and images. Further, the data compositive intelligence module 130 is also configured to derive one or more clusters. Each cluster represents a semantic relationship between each of the plurality of logical components of the document set. As used herein, semantic clustering is a process of grouping keywords based on meaning. Therefore, words with similar meanings may be organized into distinct clusters.

The multi-modal cognitive intelligence layer module 125 also includes a linguistic intelligence module 140 configured to analyze one or more textual components from the document set. The textual components include paragraphs, sentences, and clause structures. As used herein, the textual components are the words present in a sentence. The linguistic intelligence module 140 is adapted to understand the meaning of words, sentences, grammar that binds sentences, entities, and relationship between the entities.

Further, the linguistic intelligence module 140 is also configured to link each of the plurality of textual components to a corresponding plurality of attributes. Typically, the attributes of an entity give information about characteristic features of an entity. For example, a single unique object in the real world that is being mastered such as a person, product, and organization, and a characteristic type that describes the entity such as a person's date of birth, product cost, and organization name.

Furthermore, the linguistic intelligence module 140 is configured to generate a knowledge graph of document or set of documents upon understanding the relationship between the plurality of textual components. As used herein, the knowledge graph is a knowledge base that integrates data using a graph-structured data model. The document knowledge graphs are frequently used to store interconnected descriptions of entities such as names, numbers, events, sentiments, or abstract concepts. Examples of the entities include companies, people, concepts, terminologies, and the like. Further, such entities are interrelated in the given document. When data is extracted, the relationship across such entities are retained within the information structure of the document. Further, captures their relationship based on co-occurrence and co-reference such as a customer relationship between a company and a person, or a network connection between two computers. The labels capture the essence of the relationship, such as a relationship between two people.

Further, the multi-modal cognitive intelligence layer module 125 includes a mathematical intelligence module 150 is configured to analyze numerical attributes from the document set to understand a corresponding numerical relationship between data units. Typically, the numerical attributes may be ratios and mathematical operations (for instance, addition, subtraction, multiplication and division) that derives the relationship between the numbers present in the files. In other words, the relationship between every two numbers is derived. For instance, consider that the file includes 100 million to be the revenue and the breakup values of the said revenue. In such a case, the relationship between 100 million and each of the breakup values is determined. Typically, the mathematical intelligence module 150 stores the numerical relationships between the plurality of data points within the document set.

Furthermore, the multi-modal cognitive intelligence layer module 125 includes a domain intelligence module 160 configured to allow subject matter experts to configure domain knowledge into the document set.

The outcomes of the multi-modal cognitive intelligence layer module (125) includes information extraction, document classification, intelligent search and discovery, table extraction, data analytics, document TOC, document tagging, financial spreading, aspect-based sentiment analysis and topic based data classification.

In one embodiment, the various functional components of the system may reside on a single computer, or they may be distributed across several computers in various arrangements. The various components of the system may, furthermore, access one or more databases, and each of the various components of the system may be in communication with one another. Further, while the components of FIG. 1 are discussed in the singular sense, it will be appreciated that in other embodiments multiple instances of the components may be employed.

In an example, consider a user ‘X’ pertaining to an enterprise who requires document processing using the system 100. The receiving module 120 receives a document set from the user ‘X’. The document set may include structured data, unstructured data, and semi-structured data. For example, the receiving module 120 receives the unstructured data as an enterprise document that may include headings, subheadings, paragraphs, subparagraphs, sentences, numerical attributes, and images. The multi-modal cognitive intelligence layer module 125 analyzes headings, subheadings, paragraphs, subparagraphs, sentences, and images upon receiving. The data compositive intelligence module 130 provides a hierarchy of logical components. For example, the data compositive intelligence module 130 provides the hierarchy between the headings, subheadings, paragraphs, subparagraphs, sentences, and images. The top section of the hierarchy may be headings, and the bottom section of the hierarchy may be images. The linguistic intelligence module 140 derives a plurality of clusters. For example, destination’ and ‘last stop’ are semantically the same but different in various contexts and the linguistic intelligence module 140 derive the clusters based on semantic relationships. The linguistic intelligence module 140 generates a document knowledge graph upon understanding the semantic relationships. The document knowledge graphs provide a method to extract and correlate multimodal and related information from diverse and heterogeneous unstructured documents.

The mathematical intelligence module 150 analyzes a relationship between numerical attributes. For example, 2+3=5, the mathematical intelligence module 150 analyzes the relation between 2, 3, 5, and an addition symbol. The domain intelligence module 160 allows subject matter expert ‘Y’ to configure their domain knowledge into the system to build domain-specific solutions.

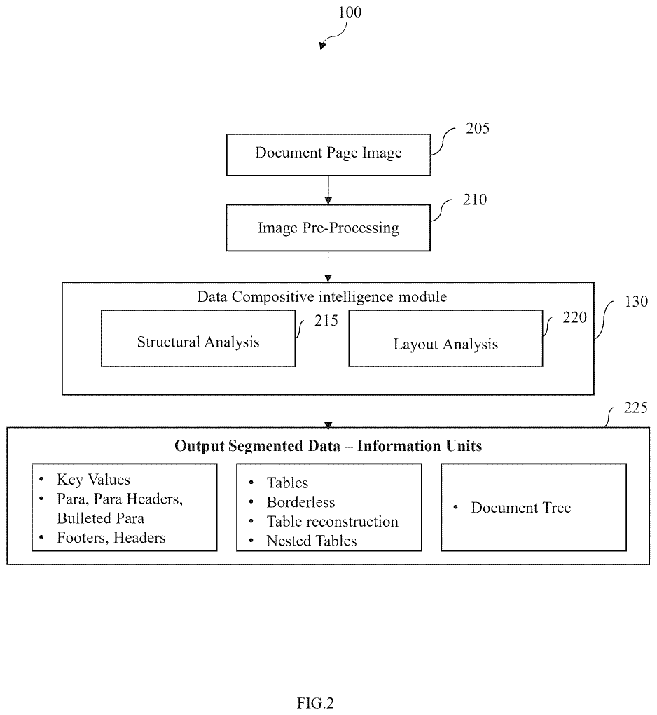

FIG. 2 is a block diagram of a data compositive intelligence module of FIG. 1 in accordance with an embodiment of the present disclosure. The images 205 of the documents is the input for image pre-processing 210. The data compositive intelligence module 130 is accountable to analyze the structure and layout of the documents. The data compositive intelligence module 130 includes two parts namely, the structural analysis 215 and layout analysis 220. The structural analysis 215 examines the documents to identify a structure in terms of paragraphs, headers and footers. Likewise, the layout analysis 220 examines the visual layout of the documents in terms of tables and borders.

After analysis, the documents are segmented into several ‘information units’ or meaningful segments 225 that can be easily processed and understood. For instance, the textual elements identified in the documents are key values, para, para headers, bulleted para, footers, headers. Key values represent the essential data points within a document that hold critical meaning. These could include metrics like total amount, dates, or references in an invoice or contract. Para, para headers and bulleted para refer to the structural components of text within a document. Specifically, para are blocks of text that convey complete thoughts or information, para headers are Titles or headings that summarize the content of a paragraph, helping users understand its subject and bulleted para are Lists or points organized in a bullet format for readability and easy navigation of information. Headers are information that appears at the top of each page, often containing metadata like document title, date, or author. Similarly, footers are information that appears at the bottom of each page, such as page numbers, footnotes, or additional document metadata.

Likewise, tabular data and its different formats in the documents are represented in tables, borderless, table construction and nested tables. Further, the document tree represents the hierarchy of the document's structure, showing how different elements relate to one another. Tables present data in a structured, row-column format, making it easier to view and compare related data points. These are tables without visible borders or outlines, which may be harder to detect using traditional document processing methods. The process of rebuilding the structure of tables after they are extracted from documents, especially in cases where the table structure is distorted due to document formatting (like PDFs, images). Tables that contain other tables within them, often used in complex documents like financial reports, where data is organized in a layered manner. Nested tables contains other tables within them, often used in complex documents like financial reports, where data is organized in a layered manner.

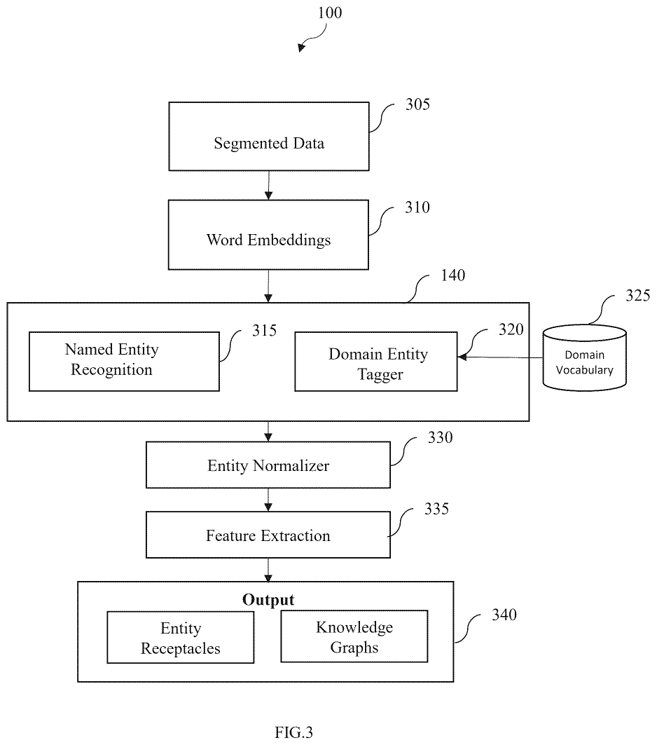

FIG. 3 is a block diagram of a linguistic intelligence module of FIG. 1 in accordance with an embodiment of the present disclosure. The linguistic intelligence module 140 identifies and categorizes entities within documents. The input to the linguistic intelligence module 140 is segmented data 305 that includes word embeddings 310. The segmented data 305 refers to structural contents of the documents such as text blocks, paragraphs, non-paragraphs, sentences and phrases. The word embeddings 310 represents words as vectors in a multi-dimensional space, that encodes the meaning of the word in such a way that the words that are closer in the vector space are expected to be similar in meaning. This is analyzed by the named entity recognition (NER) 315 and domain entity tagger. The NER 315 is responsible for identifying named entities in the text, such as names of people, organizations, locations, dates and other specific data points. Further, the NER 315 is also responsible for identifying predefined categories of named objects and concepts. After identifying the named entities, it standardizes or normalizes named entities across a corpus of text or datasets. It also ensures that variations, abbreviations, or misspellings of a named entity are recognized as the same entity.

Similarly, the domain entity tagger 320 is responsible for identifying entities specific to a particular domain by using a variety of techniques such as context-aware recognition, applying domain-specific vocabulary database. The Domain Vocabulary 325 acts as a Repository of specific subject matter/domain terms or keywords with all variations of naming.

The entity normalizer module 330 is configured to standardize all identified entities for consistent representation. It ensures that variations, abbreviations, or misspellings of a named entity are recognized as the same entity.

The feature extraction module 335 is configured to process and transform raw data into numerical features that can be processed while preserving the information in the original data set.

The Domain Entity Tagger is configured to identify and classify domain-specific entities within a text-for example names of drugs in pharma domain or legal domain.

The final output 340 is divided into entity receptacles and knowledge graphs. The entity receptables are structures that hold the identified and categorized entities to facilitate further analysis. The Entity Receptacles are representation matrix of entities and their relationships in a specific structure. The knowledge graphs represents relationships and hierarchies between different entities in a visual representation.

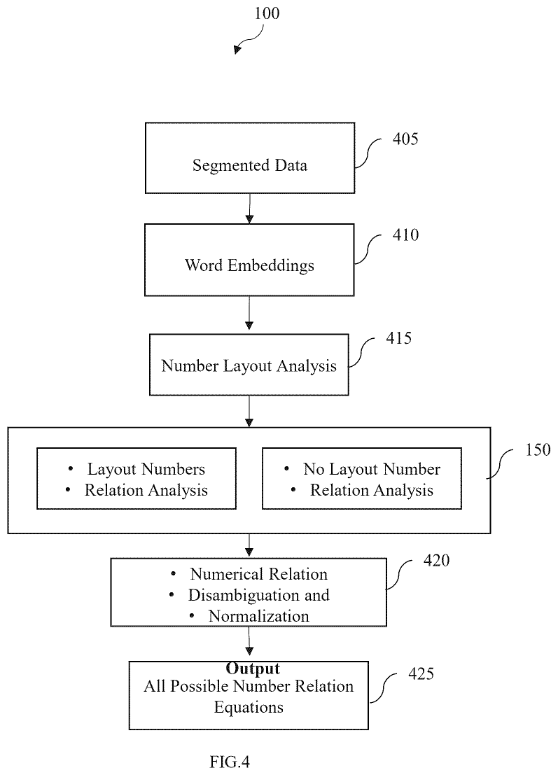

FIG. 4 is a block diagram of a mathematical intelligence module of FIG. 1 in accordance with an embodiment of the present disclosure. The mathematical intelligence module 150 is typically responsible for analyzing numerical relationships in documents. The process starts with the documents 405, 410 that needs to be analyzed for numerical relationships. Number layout analysis 415 is performed on the documents. This analysis focuses on layout number relation analysis and no layout number relation analysis. The layout number relation analysis is responsible for identifying numbers that are associated with specific layouts or formats in the documents. This includes numbered lists, tables, page numbers or any numerical data that has a structure in the document's layout. The layout number relation analysis also examines how numerical data is structured within table rows and columns, facilitating better interpretation, extraction, and analysis of the data contained in structured documents. Likewise, the no layout number relation analysis is accountable to handle numbers that are not associated with a specific layout. This includes text, such as quantities, dates or standalone numerical data that do not follow a structured format in the document. The no layout number relation analysis also examines how numerical data is structured within Page of limited relations—pre-defined, facilitating better interpretation, extraction, and analysis of the data contained in structured documents. Further, number layout analysis is responsible to identify how numerical data is arranged and structured within tabular formats. This analysis is crucial in Document Intelligence for extracting meaningful information from tables, especially in financial reports, invoices, or research data.

The output 425 of the process defines all possible number relation equations.

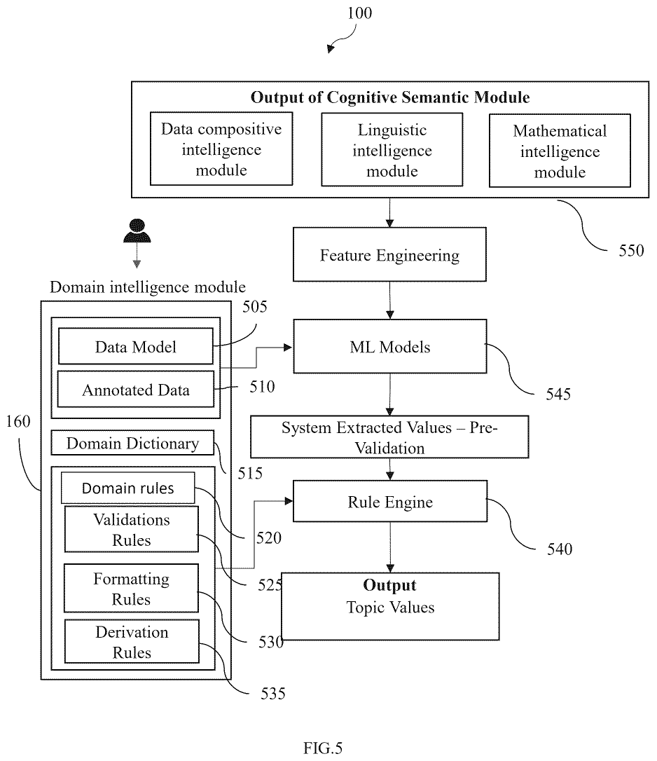

FIG. 5 is a block diagram of a domain intelligence module of FIG. 1 in accordance with an embodiment of the present disclosure. The domain intelligence module 160 includes data model 505, annotated data 510, domain dictionary 515 and domain rules 520. The domain rules 520 further includes validation rules 525, formatting rules 530 and deviation rules 535. Specifically, the domain rules 520 are injected into a rule engine 540. Typically, the data model and annotated data are fed into the ML models 545.

The data model 505 is a conceptual representation of the data fields, relationships, and constraints within a specific domain/Document set. It serves as a blueprint for how data is defined, related to one another, and represented in the extracted fields.

The annotated data 510 refers to datasets that have been enhanced with additional information or labels, typically to provide context or meaning to the raw data. This can involve tagging or marking up the data to highlight important features, categories, or relationships. Annotation can be manual or automated and is often used in machine learning to train models.

The domain dictionary 515 is a curated collection of terms, definitions, and concepts specific to a particular domain or industry. It serves as a reference to ensure consistent terminology and understanding among users working within that domain. A domain dictionary often includes synonyms, acronyms, and context-specific usage examples.

The domain rules 520 are guidelines for data integrity and consistency in a specific context relationships. The validation rules are criteria for checking the acceptability of data. Likewise, formatting rules are standards for presenting data consistently. Further, the derivation rules are used for calculating or inferring new data from existing values.

The output 550 of the cognitive semantic module is the combination of outputs from the data compositive intelligence module, linguistic intelligence module and the mathematical intelligence module. This combined output contributes to feature engineering.

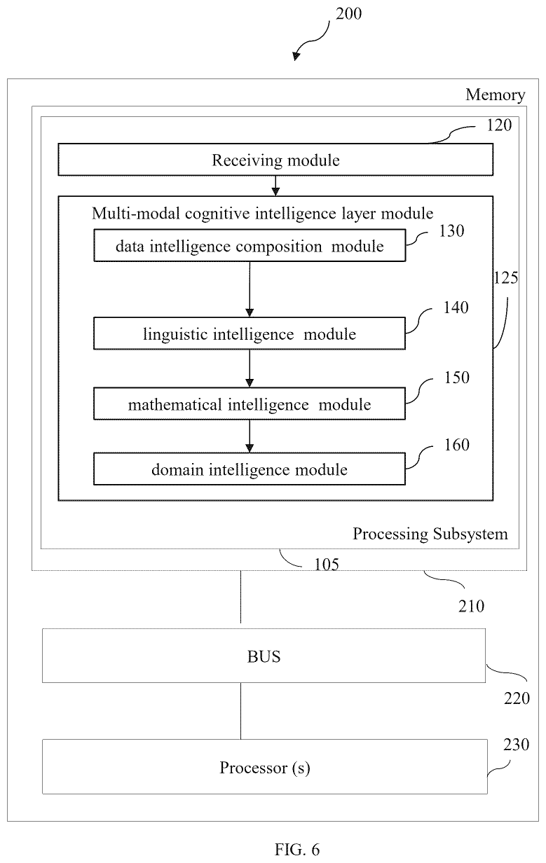

FIG. 6 is a block diagram of a computer or a server in accordance with an embodiment of the present disclosure. The server 200 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 includes a processing subsystem 105 of FIG. 1. The processing subsystem 105 further has following modules: receiving module 120, a multi-modal cognitive intelligence layer module 125, a data compositive intelligence module 130, a linguistic intelligence module 140, a mathematical intelligence module 150, and a domain intelligence module 160.

The receiving module 120 operatively coupled to the processing subsystem 105 configured to receive a document set wherein the document set includes structured data, unstructured data, and semi-structured data. The processing subsystem 105 further includes a multi-modal cognitive intelligence layer module 125 operatively coupled to the receiving module 120 including a plurality of modules to analyze content in the document set upon receiving the document set, wherein the multi-modal cognitive intelligence layer module 125 includes a data compositive intelligence module 130 configured to provide a hierarchy of one or more logical components upon understanding a structure of the content in the document set. The data compositive intelligence module 130 is also configured to derive clusters, wherein each cluster represents a semantic relationship between each of the plurality of logical components of the document set. The multi-modal cognitive intelligence layer module 125 also includes a linguistic intelligence module 140 configured to textual components from the document set wherein the textual components includes paragraphs, sentences, and clause structures. The linguistic intelligence module 140 is also configured to link each of the plurality of textual components to a corresponding plurality of attributes. The linguistic intelligence module 140 is further configured to generate a knowledge graph for the document set upon understanding the relationship between the plurality of textual components. Further, the multi-modal cognitive intelligence layer module 125 includes a mathematical intelligence module 150 configured to analyze numerical attributes from the document set to understand a corresponding numerical relationship between data units, wherein the data units pertains to the document set. Additionally, the multi-modal cognitive intelligence layer module 125 includes a domain intelligence module 160 configured to allow subject matter experts to configure domain knowledge into the document set.

The bus 220 as used herein refers to internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus, and the like.

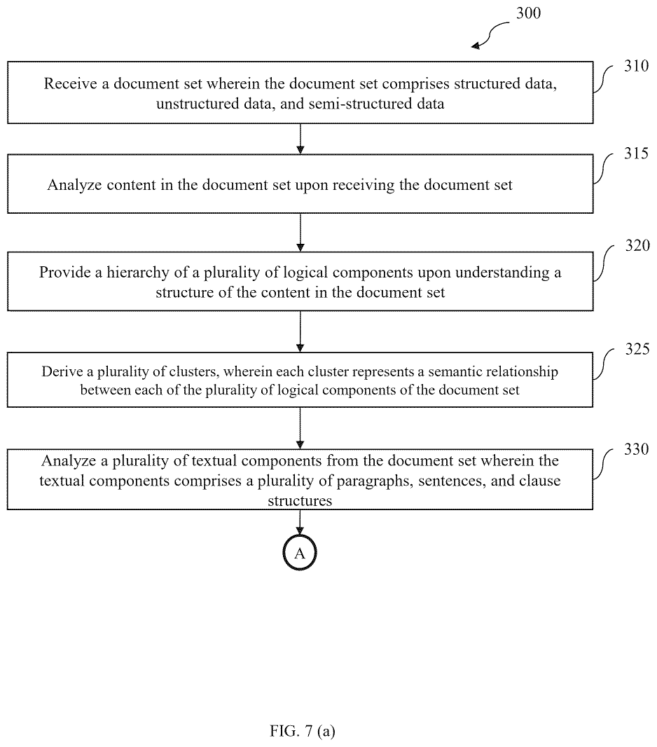

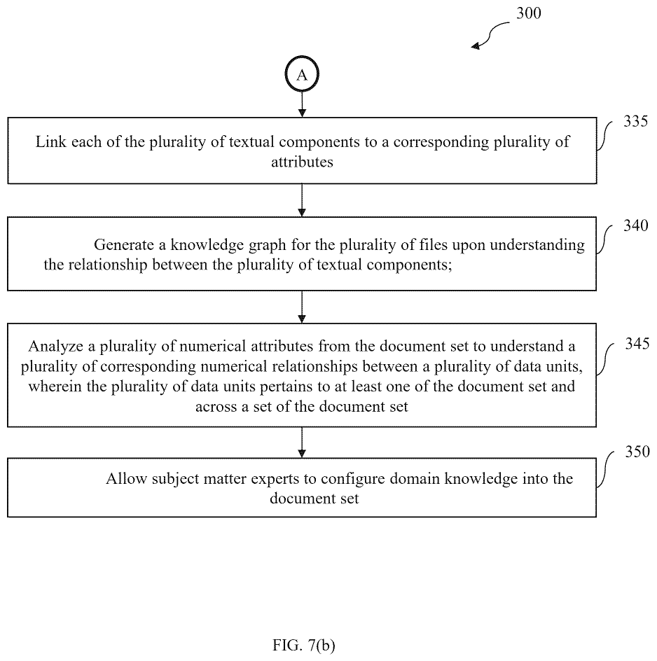

FIG. 7(a) illustrates a flow chart representing the steps involved in a method for enterprise document processing using cognitive intelligence in accordance with an embodiment of the present disclosure. FIG. 7(b) illustrates continued steps of the method of FIG. 7(a) in accordance with an embodiment of the present disclosure.

The method 300 includes receiving a document set wherein the document set includes structured data, unstructured data, and semi-structured data in step 310. Typically, the document set is in any format, for instance, pdf, word, image, websites, databases and the like. Examples of the document set, or documents includes, but is not limited to, quarterly or annual reports, estimate research reports, company filings, insurance documents, master agreements and amendments, term sheets, websites, press releases, invoices, emails, industry-specific contracts, service agreements, fund prospectus and bond documents.

In one embodiment, a user is allowed to share a sample set of input-output documents or test data for a given use case and specifies output requirements. Alternatively, the user is allowed to provide input-output samples from past data. It must be noted that the input-output documents and samples act as the training data set for the Artificial Intelligence model. Further, additional data sets may be provided by the user based on the output requirements. In such an embodiment, the input-output documents or test data may be stored in a central repository such as a server and then distributed among end points within the network, or some combination of these. Sharing may, for example, include automatically or manually sharing the input-output documents or test data in a known directory, or owned by one or more users with known roles in the enterprise.

In one embodiment, insights from the structured data and unstructured data may be extracted by using artificial intelligence technique and machine learning technique.

The method 300 also includes analysing content in the document set upon receiving the document set in step 315. The content is analysed using Artificial Intelligence (AI) to understand and process the documents contextually. In one embodiment, Natural Language Processing (NLP) and Machine Learning (ML) are utilized to automatically extract, classify and validate the document set.

In one embodiment, the document is set extracted by one of supervised learning technique and unsupervised learning technique.

Further, the method 300 includes providing a hierarchy of a plurality of logical components upon understanding a structure of the content in the document set in step 320. Typically, the data compositive layer module also provides the hierarchy of the plurality of logical components by analyzing a visual representation of the document set. As used herein, the plurality of logical components includes at least one of headers, sections, paragraphs, images, and tables. It will be appreciated to those skilled in the art that the logical components are the elements that form the structure, style and content of information in the file (document).

Further, the method 300 also includes deriving a plurality of clusters, wherein each cluster represents a semantic relationship between each of the plurality of logical components of the document set in step 325. Typically, clustering is grouping similar data together.

In one embodiment, deriving a plurality of clusters using one of k-means clustering and hierarchical clustering.

Furthermore, the method 300 includes analyzing a plurality of textual components from the document set wherein the textual components include a plurality of paragraphs, sentences, and clause structures in step 330.

The method 300 includes linking each of the plurality of textual components to a corresponding plurality of attributes in step 335.

The method 300 also includes generating a knowledge graph for the document set upon understanding the relationship between the plurality of textual components in step 340. As used herein, the knowledge graph is formed upon connecting a plurality of attributes between a plurality of phrases wherein the attributes are words used in the document set.

Furthermore, the method 300 includes analyzing a plurality of numerical attributes from the document set to understand a plurality of corresponding numerical relationships between a plurality of data units, wherein the plurality of data units pertains to at least one of the document set and across a set of the document set in step 345. Typically, the mathematical intelligence module stores the numerical relationships between the plurality of data points within the document set.

At the end of step 345, a working pre-trained AI model is provided to the user. Subsequently, the user utilizes the said AI model to generate output for a new set of documents. It must be noted that the AI model continues to learn from repeated document processing and from experts in the art to incrementally improve the accuracy of results.

Additionally, the method 300 includes allowing subject matter experts to configure domain knowledge into the document set in step 350.

It must be noted that the method 300 delivers several outcomes such as information extraction, document classification, Intelligent search and discovery, table extraction, data analytics, document TOC, document tagging, financial spreading, aspect-based sentiment analysis and topic-based data classification.

In one embodiment, the users are enabled to find specific data or documents through advanced search filters or by using topic based guided navigation.

The system and method described herein is applicable to several application areas, for instance, enterprise customers, Business Process Outsourcing (BPOs)/Knowledge Process Outsourcing (KPOs), system integrators, independent software vendors, Robotic Process Automation (RPA) vendors, process mining and automation providers, banking and finance, insurance, legal, pharma, logistics, energy and utilities, and manufacturing.

Various embodiments of the system and method for enterprise document processing using cognitive intelligence as described above provide an understanding of structured data, unstructured data, and semi-structured data upon processing thereby solving unstructured data challenges by utilizing the layer module. The data compositive intelligence layer module provides clusters upon understanding the data thereby providing a semantic relationship between the logical components. The linguistic intelligence module provides the knowledge graph thereby understanding the relationship between the words. The mathematical intelligence layer module provides a relationship between numerical attributes, thereby understanding each numerical attribute. The domain intelligence layer module allows subject matter experts thereby understanding the domain of the document set.

Further, the system and method described above processes the documents based on its context, therefore making it template-free processing. Further, the documents are fetched from multiple channels, for instance existing systems, databases and specified folders for processing. Furthermore, the use of Artificial Intelligence to analyze the documents increases efficiency and saves cost and time.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing subsystem” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for enterprise document processing using cognitive intelligence comprising:
a processing subsystem hosted on a server, wherein the processing subsystem is configured to execute on a network to control bidirectional communications among a plurality of modules comprising:
a receiving module operatively coupled to the processing subsystem configured to receive a document set stored in a repository wherein the document set comprises at least one of structured data, unstructured data, and semi-structured data;
a multi-modal cognitive intelligence layer module operatively coupled to the receiving module wherein the multi-modal cognitive intelligence layer module is configured to analyze content in the document set, wherein the multi-modal cognitive intelligence layer module comprises:
a data compositive intelligence module configured to:
provide a hierarchy of one or more logical components upon understanding a structure of data content in the plurality of files, consisting of visual and structural presentation of hierarchy of data;
derive a plurality of data clusters from the hierarchy, wherein each of the plurality of data clusters represents a semantic relationship between the one or more logical components;
a linguistic intelligence module configured to:
analyze one or more textual components from the document set wherein the one or more textual components comprises words, phrases, clause structures, sentences and paragraphs;
link each of the one or more textual components to a corresponding attribute; and
generate a knowledge graph upon understanding the relationship between the one or more textual components;
a mathematical intelligence module configured to analyze a plurality of numerical attributes in the document set to understand numerical relationships between one or more numbers wherein the one or more data units pertains to the document set; and
a domain intelligence module configured to allow subject matter experts to configure domain knowledge such as business rules or import domain-specific data from the plurality of files.

2. The system as claimed in claim 1, wherein the document set comprises at least one of images, portable document format, and word document.

3. The system as claimed in claim 1 wherein the document set are pre-processed to reduce noise, correct skew and convert format.

4. The system as claimed in claim 1, wherein the logical components comprises at least one of a plurality of headers, a plurality of sections, a plurality of paragraphs, a plurality of images, and a plurality of tables.

5. The system as claimed in claim 1, wherein the knowledge graph is formed upon connecting a plurality of attributes between a plurality of phrases wherein the attributes are words used in the document set.

6. The system as claimed in claim 1, wherein the data compositive layer module provides the hierarchy of the plurality of logical components by analyzing a visual representation of the document set.

7. The system as claimed in claim 1, wherein the mathematical intelligence module stores the numerical relationships between the plurality of numbers within the document set.

8. The system as claimed in claim 1, wherein the knowledge graph comprises key information and the relationship between the key information of the document set.

9. A method for enterprise document processing using cognitive intelligence comprising:
receiving, by a receiving module of a processing subsystem, a document set wherein the document set comprises structured data, unstructured data, and semi-structured data;
analyzing, by a multi-modal cognitive intelligence layer module of the processing subsystem, content in the document set upon receiving the document set;
providing, by a data compositive intelligence layer of a layer module, a hierarchy of a plurality of logical components upon understanding a structure of the content in the document set consisting of visual and structural presentation of hierarchy of data;
deriving, by a data compositive intelligence layer of the layer module, a plurality of clusters, wherein each cluster represents a semantic relationship between each of the plurality of logical components of the document set;
analyzing, by a linguistic intelligence module of the layer module, a plurality of textual components from the document set wherein the textual components comprises a plurality of words, phrases, clause structures, sentences and paragraphs;
linking, by a linguistic intelligence module of the layer module, each of the plurality of textual components to a corresponding plurality of attributes;
generating, by a linguistic intelligence module of the layer module, a knowledge graph for the document set upon understanding the relationship between the plurality of textual components;
analyzing, by a mathematical intelligence module of the layer module, a plurality of numerical attributes, underlying patterns, correlations and numerical relationships between a plurality of numbers which pertain to at least one of the document set and across a set of the document set; and
allowing, by a domain intelligence module of the layer module, subject matter experts to configure domain knowledge such as business rules, validation rules, domain-specific data for the document set.
